(19) United States
(12) Patent Application Publication
(10) Pub. No.: US 2016/0241623 A1
(43) Pub. Date: Aug. 18, 2016

(54) COMMUNICATIONS PLATFORM

(71) Applicant: ARGENT LINE, LLC, Springfield, VA (US)

(72) Inventors: George ZOULIAS, Springfield, VA (US); Joshua MADDEN, Springfield, VA (US); Kevin POWELL, Springfield, VA (US)

(73) Assignee: ARGENT LINE, LLC, Springfield, VA (US)

(21) Appl. No.: 15/026,704

(22) PCT Filed: Oct. 1, 2014
(86) PCT No.: PCT/US14/58647

§ 371 Date: Apr. 1, 2016

Related U.S. Application Data
(60) Provisional application No. 61/885,426, filed on Oct. 1, 2013.

(51) Int. Cl. H04L 29/06; H04M 7/00; H04M 3/56

(52) U.S. Cl. CPC H04L 65/601; H04L 65/80; H04M 3/56; H04M 7/006

(57) ABSTRACT

A communications platform bridge gathers information from remote areas, including war battlefields, in order to redistribute the information that is gathered throughout a network. The communications platform includes a router, a compute node, an encoder, and a streaming media server. Additionally, the communications platform may include services providing a session protocol server, an application server, a chat server, a time server, a file storage server, and a map server.

### BACKGROUND

### Technical Field

The subject matter disclosed herein is generally directed towards a communications platform, and in particular, a communications platform bridge that facilitates a modular communications suite. Until now, there has been a need for a portable dynamically modular communications suite that takes the capabilities of a whole room of communications equipment, condenses it into a space weight and power of a system that fits into a briefcase or on a laptop computer, and provides interoperability, interchangeability, and ready intercommunication with virtually any device or service. Consequently, a novel dynamically modular communications suite has been developed, especially for use in tactical and national arenas, while providing complete interoperability throughout an enterprise and requiring low overhead.

### SUMMARY

In accordance with the features of the present subject matter, an apparatus for a communications platform bridge and a communications network is provided that allows any type of data communications to be adapted and communicated through any network. The communications platform bridge includes a router (an optional component) that is configured to facilitate communications with Wide Area Networks (WAN), establishment of Local Area Networks (LAN), the protection of LAN via a firewall, and the protection of data in transit via a Virtual Private Network (VPN) tunnel.

The platform provides a physical or virtual intercommunications fabric for one or more services modules including, but not limited to, networking appliances (routers, switches, firewalls, access points, and gateways), computing appliances (hosts for services), storage appliances, radio to VoIP bridge appliances, video encoders/decoders, sensor gateways, VoIP gateway services, file sharing services, chat services, and collaboration services.

An encoder arranged with the router has at least one input that is configured to receive and encode data from the router. A radio bridge module can be arranged near the router and configured to route the data and connect to at least one radio, and a virtual machine is configured to stream, manage and access the data.

The communications network includes a router that is configured to manage data. At least one expansion module is arranged near the router with radio adapters, and near the router a high-definition serial digital interface (HD-SDI) video encoder is configured with at least four inputs. A radio bridge module arranged alongside the expansion module is configured to convert standard military radios into Internet protocol (IP). A module is arranged to provide access for a server to stream media including video and audio feeds, wherein a voice over internet provider (VoIP) and Mobile and Tactical Radio networks are provided.

A mobile application framework connects into the communications network through the server or a virtual machine and the provided application store is arranged to manage applications and data routed from the communications platform bridge.

### BRIEF DESCRIPTION OF THE DRAWINGS

FIG. 1 is a non-limiting exemplary embodiment of a portable communications platform network.

FIG. 2 is a non-limiting exemplary embodiment of a communications platform bridge including a router, an encoder, and a radio bridge.

FIG. 3 is a non-limiting exemplary embodiment of multimedia collaboration with a dynamically modular communications suite.

### DETAILED DESCRIPTION

The subject matter disclosed herein is generally directed towards a system that integrates and manages modules, including systems and services, and provides them to local users while facilitating reach back to remote users.

Possible systems modules described herein provide, but not exclusively, the following functionality and support:

radio to Voice over internet protocol (IP) bridging;

Voice over IP gateway;

Video Tele-Conferencing Gateway;

Virtual Private Network Gateway;

Network Security Appliance

Wireless Network Appliance (Wi-Fi Access Points, Cellular Data Access Points);

IP Network Encryption Appliance;

Video Encoder/Decoder;

Audio Encoder/Decoder;

Sensor or other device Gateway;

Computing appliance; and

Storage Appliance.

The services described herein include, but are not limited to, the following items:

Communications (chat, voice, video);

Collaboration (filesharing, social networking, maps);

Distribution (video, maps, files, audio, communications);

Storage (recording of video and audio, filesharing);

General Purpose Computing (virtual desktop); and

Information Systems Security (anti-malware, network security).

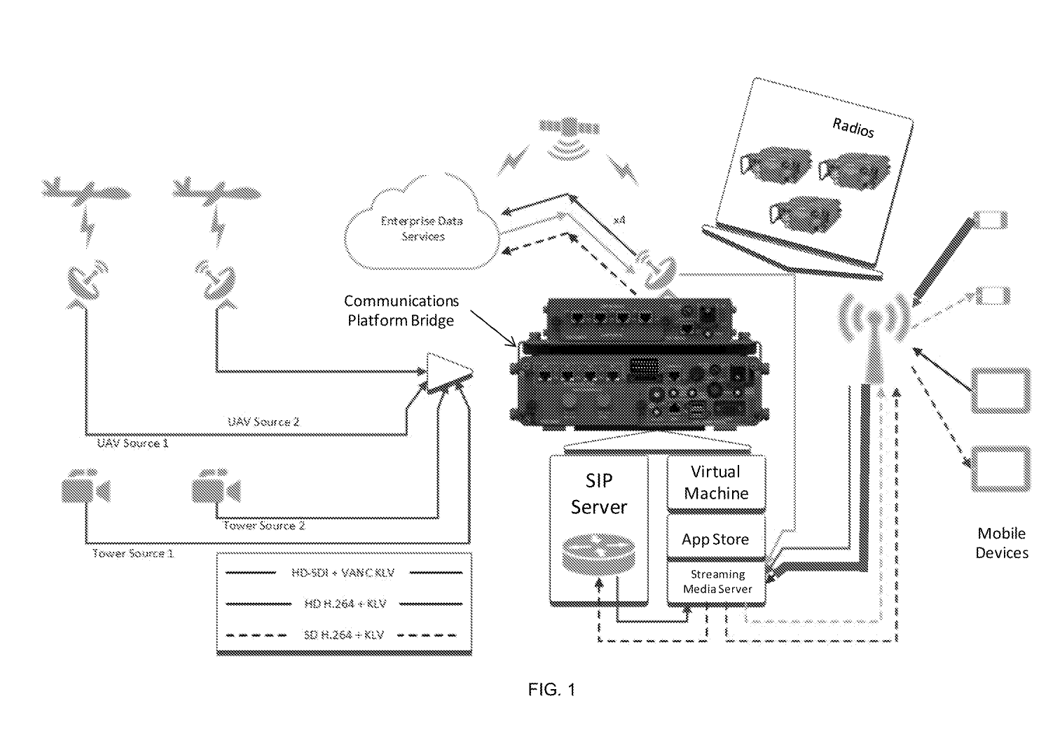

Shown in FIG. 1 is a non-limiting exemplary embodiment of a network comprising the presently disclosed system, the system provides a fabric that is a physical chassis or virtual component that facilitates integration, intercommunication, and management of modules. In addition, the fabric provides a local network for subscribers to use platform services. The fabric also provides a path to communicate with external networks and services. As shown, there is a communications platform bridge connected to enterprise data services, for example, by satellite. Installed with the communications platform bridge, as virtual machines (VM's) or software implementations of a targeted machine that executes a program, such as a computer, are: a session initiation protocol server, an application server, and a streaming media server, by way of non-limiting example. The communications platform bridge is configured to connect to an existing cellular network. In the alternative, the communications platform bridge is configured to create a cellular network by means of a cellular base station, for example a picocell. Accordingly, the communications platform bridge is capable of connecting and communicating with mobile devices, either through an existing network or by creating a new network.

Non-limiting exemplary data, surveillance and reconnaissance (ISR) gathering devices are shown in FIG. 1 as unmanned aerial vehicles and video cameras. Photos, videos, and other data gathered by those exemplary ISR gathering devices are transmitted to the enterprise data services. The communications platform bridge is configured to receive the gathered data from the enterprise data services. In an alternative embodiment, the communications platform bridge is configured to receive the gathered data directly from the ISR gathering devices.

In the exemplary network comprising the communications platform shown in FIG. 1, real-time gathering and redistribution of video, audio, and/or picture data is possible, in part, because the data formats used are compatible, or at least convertible to be viewed on various devices.

Accordingly, in the exemplary network shown, video taken using a mobile device can be distributed throughout the network, including back to the enterprise data services, in proper format. Additionally, any data associated with the video, and any associated mobile devices, can be encoded and/or transcoded with the distributed video. This data includes, but is not limited to: location (GPS coordinates), time, direction, frame time, sensor identification or device name/number. Additionally, location data can be directly shown on a map.

Further, photos, videos and other information gathered by the exemplary ISR devices can be accessed by mobile devices connected to an existing cellular network, or the cellular network created by a cellular base station, as indicated above.

A VoIP Gateway module provides subscribers with a voice network that communicates with other voice networks including, but not limited to other VoIP and/or plain old telephone service (POTS).

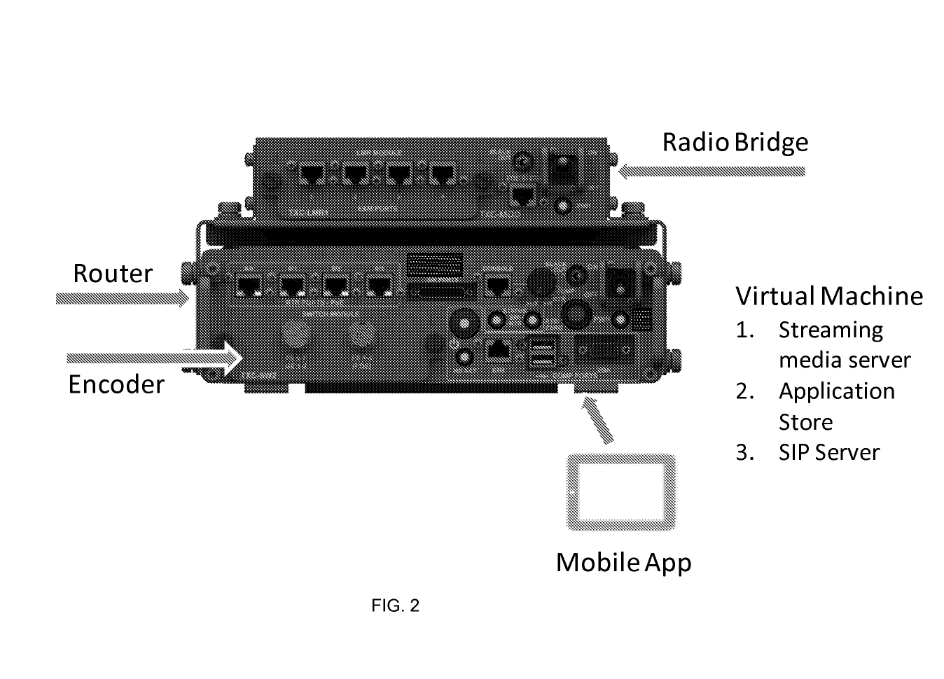

Shown in FIG. 2 is a non-limiting exemplary embodiment of a physical chassis with modules including, but not limited to, a router, an encoder and a radio bridge that provides services including, but not limited to, VoIP gateway services, file sharing services, chat services, and collaboration services, and networks including, but not limited to, mobile and radio networks. Further included with this particular embodiment of the communications platform bridge are a streaming media server, application store, and session initiation server installed as VM's.

In a non-limiting embodiment, the system includes a basic embodiment of a rugged physical chassis and modules including, but not limited to, a rugged physical chassis and a router, computing module, video encoder, wireless networking access point, and a radio to VoIP bridge appliance. Additionally, the computing module provides a virtualization platform for running services and servers.

More specifically, the system may include a router with Quality of Service (QOS) and embedded computer; an optional expansion module containing radio adapters; a video encoder; a converter operable to convert standard military radios into internet protocol; a streaming media server; a mobile application framework for Android and other mobile systems; a map tile and data providing system; a file storage system; a chat server; an authentication service; a plugin application operable to provide media communications functionality; and a server configured to provide access between voice over internet provider (VoIP), mobile and radio networks. The communications platform further comprises an applications store that allows for management of applications and data from the communications platform.

A non-limiting exemplary embodiment of the communications platform bridge comprises, for example, the following components:

TXC4—router with QOS and embedded computer;

TXC-MOD—provides an expansion module for expanding the router and contains radio adapters;

Makito—HD-SDI Video encoder (2 inputs or 4 inputs);

Vocality—converts standard military radios into IP;

Argent Prism—streaming media server;

Android Tactical Assault (ATAK) App—provides a mobile application framework for Android Systems, however other mobile operating systems, such as iOS, can be supported;

App Store—a node or server deployed framework that enables a user to access additional application packages installable onto a mobile device; and

Session Initiation Protocol (SIP) Server—provides access between VoIP, Mobile and Tactical Radio networks.

As shown in FIG. 2, the ruggedized chassis includes, but is not limited to, the following systems modules:

a wired router;

a wireless access point;

a storage module; and

a video encoder module.

Also shown in FIG. 2, the ruggedized chassis includes, but is not limited to, the following services modules:

VoIP gateway services;

video distribution services;

file sharing services; and

chat services.

The router is arranged as a man-portable chassis for the communications platform bridge and includes a mobile ad hoc network (MANET) with local area wireless technology or a MANET Wi-Fi feature card. The MANET is typically a dual radio router with at least two embedded radio modules that operate in standard frequency bands including, but not limited to, 2.3 to 2.5 GHz and 5 GHz, and optionally in frequency bands of 700 MHz, 900 MHz, 3.5 GHz, and 4.9 GHz. The router further includes a serial ATA (SATA) expansion hard drive bay, a switch feature card, and a land mobile radio feature card. The switch feature card is arranged with at least four fast Ethernet ports and routable interfaces that support virtual local area network (VLAN) tagging. In addition, the land mobile radio feature card includes a session initiation protocol (SIP) media gateway that is WAVE compatible, voice activation keying detection, and a silence suppression feature.

The encoder having at least one serial digital interface (SDI) input is configured to encode video, audio and ancillary data; perform multi-bitrate (MBR) streaming and synchronize key-length-value (KLV) metadata. As shown in FIG. 1, in a non-limiting embodiment, the encoder may be connected to UAV and tower sources including, but not limited to, HD-SDI+VANC KLV, HD H.264+KLV, and SD H.264+KLV. Further, the media server running on the embedded computer is a virtual machine (VM) with multiple bitrate, resolution and frame rate outputs for feeding several diverse endpoints simultaneously. The information node plug-in provides the communications platform the ability to access video and audio feeds on a media server, connect into SIP and VoIP networks, interact with an applications store, provide directory services, and improve mobile streaming. The applications store provides centralized management of mobile data packages and content that allows for federated access.

The above non-limiting example of the communications platform includes the following features, benefits and security: a man-portable, video and radio platform; a video and audio distribution and access system; may be employed using commercial-off-the-shelf (COTS) subsystems; may employ certified video encoders and managers; supported mobile applications. The communications platform described herein is further capable of interoperating with, but not limited to: call managers, session initiation protocol (SIP) servers; cellular networks; radios; and warfighter information network-tactical (WIN-T).

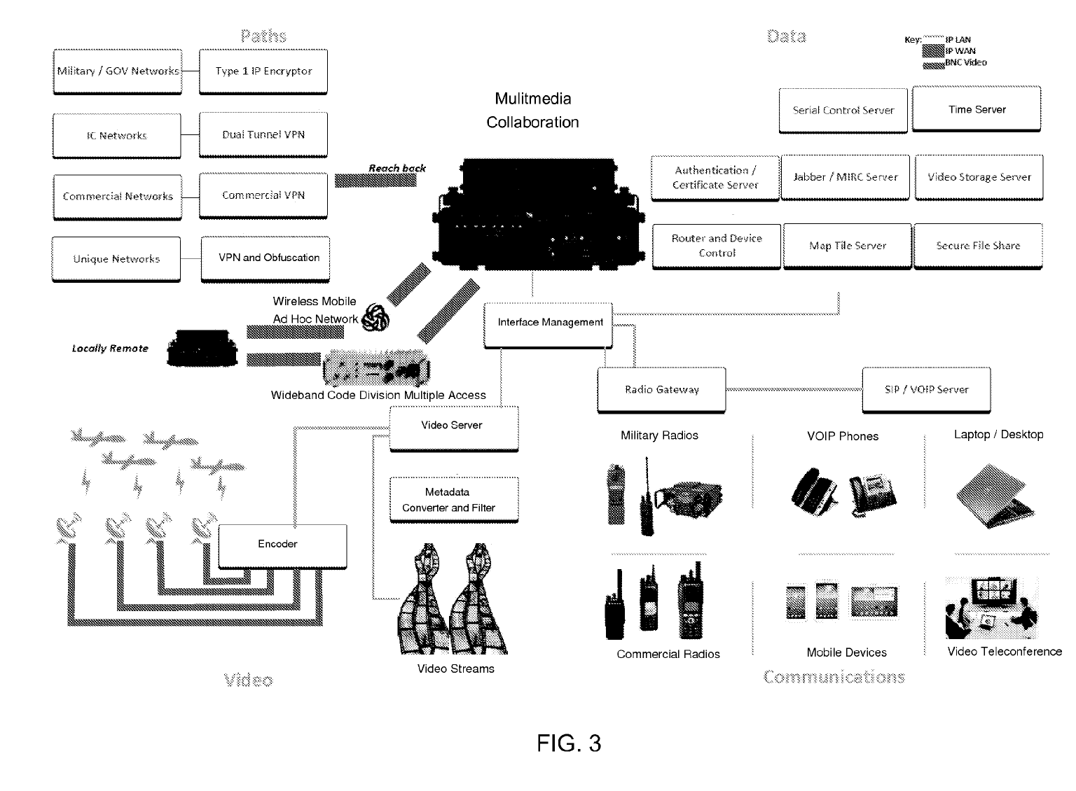

FIG. 3 shows a non-limiting exemplary embodiment of multimedia collaboration with a communications platform bridge. The communications platform bridge translates data into multimedia representations for transmission to an end user and/or devices. A single user interface management system connects to data, communications, and video servers and gateways of any type. These servers include, but are not limited to, a serial control server, hardened time server, a local or enterprise authentication/certificate server, a chat server or an extensible messaging and presence protocol (XMPP) based Jabber/mIRC server, motion industry standards board (MISB) compliant video storage server with key length value (KLV), a secure shell (SSH) and terminal hypertext transfer protocol (HTTP) device control, web map service (WMS) based layers and tiles over a map tile server, and a secure file share including encrypted data at rest with authentication.

A non-limiting exemplary embodiment of the dynamically modular communications suite includes a novel hardened time server. Additional novel servers or systems developed for use in the present communications suite include a single user interface management system; a video distribution, transcoding, and recording server; a metadata converter and filter; and a VPN and network profile obfuscation system.

As shown in FIG. 3, the single user interface management system connects a radio gateway that provides a radio interface and control to a session initiation protocol (SIP) server for controlling voice over internet protocol (VOIP) with commercial nodes. The radio gateway is arranged to include military and commercial radios. Non-limiting examples of military radios include, but are not limited to, AN/PRC-152, AN/PRC-154 and AN/PRC-117G. Non-limiting examples of commercial radios include, but are not limited to, XTS-5000 XPR and XTS-2500. The commercial nodes include VOIP phones, laptops, desktops, Android mobile devices, and video teleconference systems. Non-limiting examples of VOIP phones include, but are not limited to, VVX-500 and 7965G. The mobile devices can also provide text-based communication between two or more participants over a network.

The single user interface management system also connects a video distribution, transcoding and recording server via a LAN. This video, transcoding, and recording server is configured to be able to connect over one hundred internet protocol audio-video-metadata streams with enhanced network services, such as protocol selection, unicast, multicast, and On Demand. Also included in this data stream is a metadata converter and filter. The metadata type includes, but is not limited to, KLV, Cursor on Target (COT), Line 21 and MISB metadata. The video distribution, transcoding and recording server connects to the encoder over a LAN, and the encoder, via at least one Bayonet Neill-Concelman or Baby N Connectors (BNC) or other similar connector, provides quick connect/disconnect connector for at least one raw, un-encoded video source. The video sources include, but are not limited to, HD/SDI, SD/SDI and NTSC.

A wide area network (WAN) allows the platform bridge data communications to reach back to networks including, but not limited to, a novel or off-the-shelf VPN and network profile obfuscation system over a unique network using a network analyzer, such as SPECOM®; a VPN tailored to a client over a commercial network; an integrated dual tunnel VPN over an integrated circuit (IC) network utilizing Suite B or Next Generation Encryption; and a type one IP encryptor with user configurable packet sharing over military or government networks. The platform bridge further communicates over the WAN to a wireless mobile ad hoc network, such as Persistent Systems Wave Relay®, and over a self-contained Wideband Code Division Multiple Access device, such as the KnightHawk® system, to additional dynamic modular communications suites.

1. A communications platform bridge, comprising:
a router arranged with at least one embedded module and configured to send data over a predetermined frequency band;
an encoder arranged with the router having at least one input and configured to receive and encode data from the router;
a radio bridge module arranged with the router and configured to route the data and connect to at least one audio source; and
a virtual machine configured to stream, manage and access the data.

2. The communications platform of claim 1, further comprising an expansion module for radio adapters, thereby expanding a router capacity.

3. The communications platform bridge of claim 1, wherein said router may be configured with at least one quality of service (QOS) algorithm and at least one of an embedded, laptop or rack mounted computer.

4. The communications platform bridge of claim 1, wherein the radio bridge module is configured to convert standard military radios into internet protocol (IP).

5. The communications platform bridge of claim 1, wherein the virtual machine is configured to stream media over a communications server, manage data packages and content, and access video and audio feeds on the communications server.

6. The communications platform bridge of claim 5, wherein a radio gateway connects a single user interface management system to the communications server, and the single user interface management system connects the radio gateway to the communications platform bridge.

7. The communications platform bridge of claim 1, wherein a single user interface management system connects at least one data server to the communications platform bridge.

8. The communications platform bridge of claim 1, wherein a reach back data connection connects at least one network path to the communications platform bridge.

9. The communications platform bridge of claim 1, wherein a single user interface management system connects at least a video server to the communications platform bridge.

10. The communications platform bridge of claim 1, further comprising a mobile network arranged to connect at least a second communications platform bridge to the communications platform bridge.

11. A communications network comprising:
a router configured to send data;
a high-definition serial digital interface (HD-SDI) video encoder configured with at least one input;
a radio bridge module configured to convert standard military radios into Internet protocol (IP);
a server configured to stream media including video and audio feeds, wherein a voice over internet provider (VoIP) and mobile and radio networks can be serviced;
an application store arranged to manage applications and data routed from the communications platform bridge.
